(19) United States
(12) Patent Application Publication
(10) Pub. No.: US 2024/0251402 A1
(43) Pub. Date: Jul. 25, 2024

(54) TID-Based UL Trigger In Wireless Communications

(71) Applicant: MediaTek Inc., Hsinchu City (TW)

(72) Inventors: Wan-Jie Cheng, Hsinchu City (TW); Chih-Hsing Chang, Hsinchu City (TW); Chia-Wei Dai, Hsinchu City (TW); Chia-Hsiang Chang, Hsinchu City (TW)

(21) Appl. No.: 18/396,634

(22) Filed: Dec. 26, 2023

Related U.S. Application Data
(60) Provisional application No. 63/480,545, filed on Jan. 19, 2023.

(51) Int. Cl. H04W 72/1268; H04L 47/2483; H04W 84/12

(52) U.S. Cl. CPC H04W 72/1268; H04L 47/2483; H04W 84/12

(57) ABSTRACT

Techniques pertaining to traffic identifier (TID)-based uplink (UL) trigger in wireless communications are described. An apparatus (e.g., an access point (AP)) transmits a TID-based trigger frame to one or more stations (STAs). The apparatus then receives a trigger-based (TB) UL transmission from at least a first STA of the one or more STAs responsive to transmitting the TID-based trigger frame. In receiving the TB UL transmission, the apparatus receives a first type of traffic corresponding to a first TID indicated by first TID information that is associated with the first STA and included in the TID-based trigger frame.

### CROSS REFERENCE TO RELATED PATENT APPLICATION

The present disclosure is part of a non-provisional patent application claiming the priority benefit of U.S. Provisional Patent Application No. 63/480,545, filed 19 Jan. 2023, the content of which being herein incorporated by reference in its entirety.

### TECHNICAL FIELD

The present disclosure is generally related to wireless communications and, more particularly, to traffic identifier (TID)-based uplink (UL) trigger in wireless communications.

### BACKGROUND

Unless otherwise indicated herein, approaches described in this section are not prior art to the claims listed below and are not admitted as prior art by inclusion in this section.

In wireless communications such as WiFi (or Wi-Fi) and wireless local area networks (WLANs) in accordance with upcoming Institute of Electrical and Electronics Engineers (IEEE) 802.11 standard(s), the stream classification service (SCS) information element (IE) in IEEE 802.11be is defined as TID-based quality of service (QOS) parameters, but the basic trigger frame in IEEE 802.11ax/be is defined as an access category (AC)-based UL trigger. Specifically, an UL basic trigger according to IEEE 802.11ax/be only has preferred AC information for AC-based UL traffic. For example, TID=4 for video traffic type and TID=5 for control traffic type, and a station (STA) has TID=4 and TID=5 traffic described in its SCS information, with both TID=4 and TID=5 belonging to the same AC, namely: AC_VI. This STA may intend to deliver its UL traffic precisely based on the parameters described in the SCS IE. However, an access point (AP) may inform the STA with only the AC information, instead of TID information, in a basic trigger frame transmitted by the AP to the STA. Therefore, there is a need for a solution of TID-based UL trigger to enable triggering of dedicated TID UL traffic by UL trigger frames.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to provide schemes, concepts, designs, techniques, methods and apparatuses pertaining to TID-based UL trigger in wireless communications. It is believed that aforementioned issue(s) may be avoided or otherwise alleviated by implementation of one or more of the various proposed schemes described herein. Implementations of one or more of the proposed schemes may involve a TID-based UL trigger frame generator for Wi-Fi APs and a TID-based trigger frame handler for Wi-Fi STAs, each with a TID-based UL trigger module for UL applications of multiple streams with different TIDs in a STA. The proposed schemes may be implemented in Wi-Fi generations after Wi-Fi 6, such as Wi-Fi 7, Wi-Fi 8 and beyond. For instance, Wi-Fi 7-compliant STAs may utilize SCS information to describe the precise traffic by TID. Advantageously, implementations of one or more of the proposed schemes may be backward compatible with current Wi-Fi standards in case that TID-based UL trigger frames are not supported by certain vendors of STAs, as TID-based STAs and AC-based STAs could still be triggered by the same trigger frame.

In one aspect, a method may involve an AP transmitting a TID-based trigger frame to one or more STAs. The method may also involve the AP receiving a trigger-based (TB) uplink (UL) transmission from at least a first STA of the one or more STAs responsive to transmitting the TID-based trigger frame. In receiving the TB UL transmission, the method may involve the AP receiving a first type of traffic corresponding to a first TID indicated by first TID information that is associated with the first STA and included in the TID-based trigger frame.

In another aspect, a method may involve a first STA receiving a TID-based trigger frame. The method may also involve the first STA performing a TB UL transmission responsive to receiving the TID-based trigger frame. In performing the TB UL transmission, the method may involve the first STA transmitting a first type of traffic corresponding to a first TID indicated by first TID information that is associated with the first STA and included in the TID-based trigger frame.

It is noteworthy that, although description provided herein may be in the context of certain radio access technologies, networks and network topologies such as, Wi-Fi, the proposed concepts, schemes and any variation(s)/derivative(s) thereof may be implemented in, for and by other types of radio access technologies, networks and network topologies. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation to clearly illustrate the concept of the present disclosure.

FIG. 1 is a diagram of an example network environment in which various solutions and schemes in accordance with the present disclosure may be implemented.

FIG. 2 is a diagram of an example scenario under a proposed scheme in accordance with the present disclosure.

FIG. 3 is a diagram of an example scenario under a proposed scheme in accordance with the present disclosure.

FIG. 4 is a diagram of an example scenario under a proposed scheme in accordance with the present disclosure.

FIG. 5 is a block diagram of an example communication system in accordance with an implementation of the present disclosure.

FIG. 6 is a flowchart of an example process in accordance with an implementation of the present disclosure.

FIG. 7 is a flowchart of an example process in accordance with an implementation of the present disclosure.

### DETAILED DESCRIPTION OF PREFERRED EMBODIMENTS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to TID-based UL trigger in wireless communications. According to the present disclosure, a number of possible solutions may be implemented separately or jointly. That is, although these possible solutions may be described below separately, two or more of these possible solutions may be implemented in one combination or another.

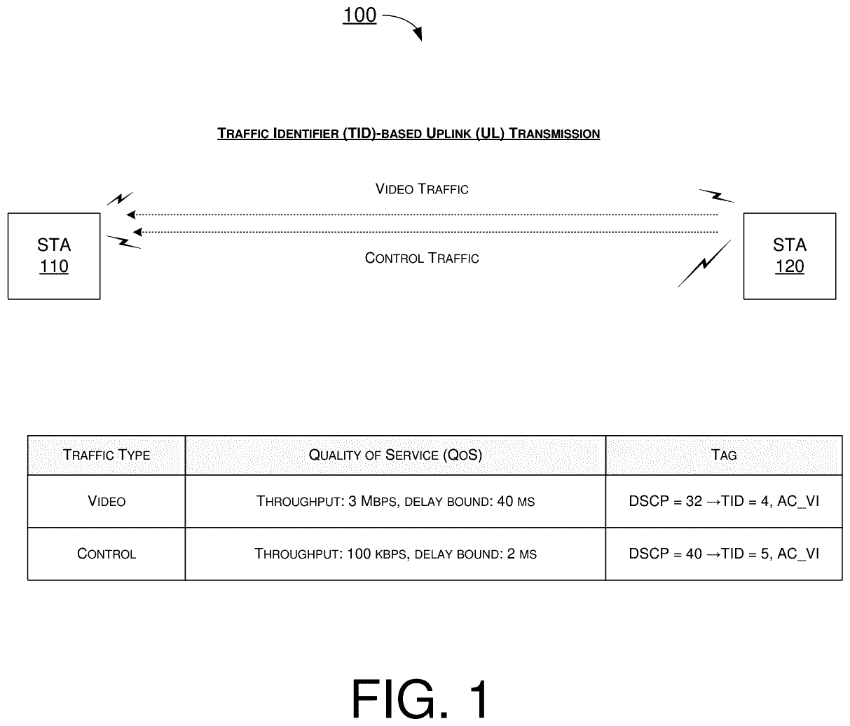

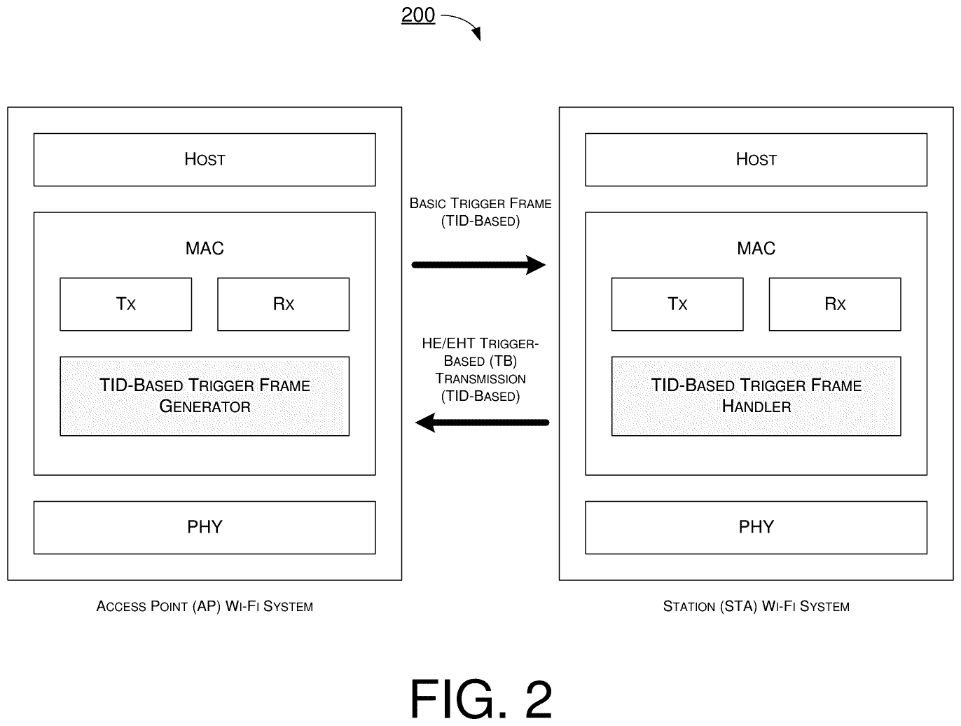

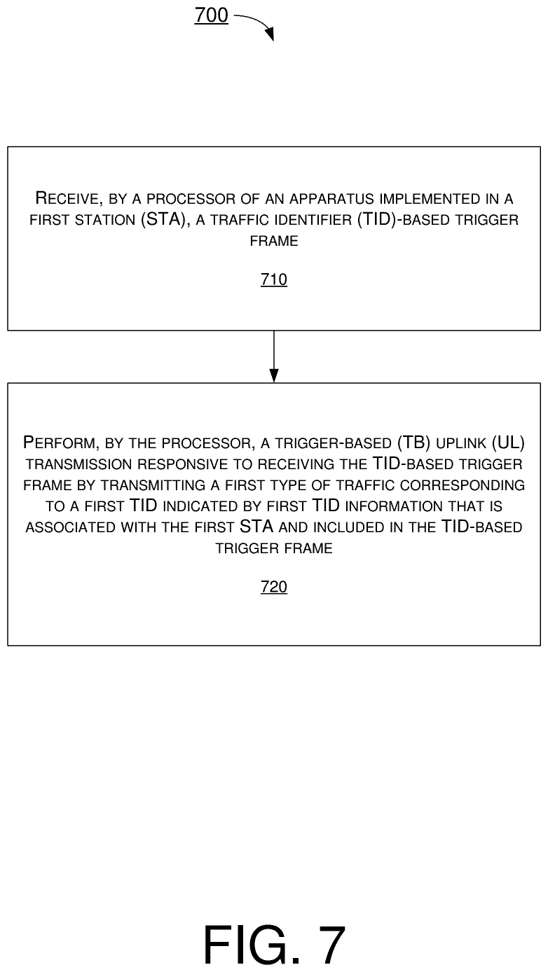

FIG. 1 illustrates an example network environment 100 in which various solutions and schemes in accordance with the present disclosure may be implemented. FIG. 2˜FIG. 7 illustrate examples of implementation of various proposed schemes in network environment 100 in accordance with the present disclosure. The following description of various proposed schemes is provided with reference to FIG. 1˜ FIG. 7.

Referring to FIG. 1, network environment 100 may involve at least a STA 110 communicating wirelessly with a STA 120. Either of STA 110 and STA 120 may be an AP STA or, alternatively, either of STA 110 and STA 120 may function as a non-AP STA. STA 110 and STA 120 may be configured or otherwise capable to operate in accordance with the same or different IEEE 802.11 standard(s) (e.g., Wi-Fi 7 and Wi-Fi 8 as well as future-developed standards). For illustrative purposes without limiting the scope of the present disclosure, in scenario 100, STA 120 may be a non-AP STA (e.g., a pair of augmented reality (AR) glasses worn by a user) and STA 110 may be an AP STA, and STA 120 may have video type of traffic and control type of traffic ready for UL transmission to STA 110. The video type of traffic may correspond to TID=4 and an AC of video, or AC_VI, and the control type of traffic may correspond to TID=5 and the AC of AC_VI. Each of STA 110 and STA 120 may be configured to communicate with each other by utilizing the techniques pertaining to TID-based UL trigger in wireless communications in accordance with various proposed schemes described below. It is noteworthy that, while the various proposed schemes may be individually or separately described below, in actual implementations some or all of the proposed schemes may be utilized or otherwise implemented jointly. Of course, each of the proposed schemes may be utilized or otherwise implemented individually or separately.

FIG. 2 illustrates an example scenario 200 under a proposed scheme in accordance with the present disclosure. Scenario 200 may involve STA 110, as an AP STA or otherwise an AP Wi-Fi system, and STA 120, as a non-AP STA or otherwise a STA Wi-Fi system. As shown in FIG. 2, the AP Wi-Fi system (STA 110) may include multiple functional layers including, among others, a host layer, a medium access control (MAC) layer and a physical (PHY) layer. Likewise, the STA Wi-Fi system (STA 120) may also include multiple functional layers including, among others, a host layer, a MAC layer and a PHY layer. The MAC layer of the AP Wi-Fi system may be configured with a transmission (Tx) module, a reception (Rx) module, and a TID-based trigger frame generator. Each of the Tx module, Rx module and TID-based trigger frame generator of the AP Wi-Fi system may be implemented, at least in part, in hardware (e.g., electronic circuitry). The MAC layer of the STA Wi-Fi system may be configured with a Tx module, a Rx module, and a TID-based trigger frame handler. Each of the Tx module, Rx module and TID-based trigger frame handler of the STA Wi-Fi system may be implemented, at least in part, in hardware (e.g., electronic circuitry). The TID-based trigger frame generator may be configured to form one or more basic (TID-based) trigger frames for transmission to the STA Wi-Fi system, and the TID-based trigger frame handler may be configured to handle the one or more TID-based trigger frames received from the AP Wi-Fi system and provide high-efficiency (HE) and/or extremely-high-throughput (EHT) (TID-based) trigger-based (TB) PHY protocol data unit (PPDU) for transmission as reply to the AP Wi-Fi system.

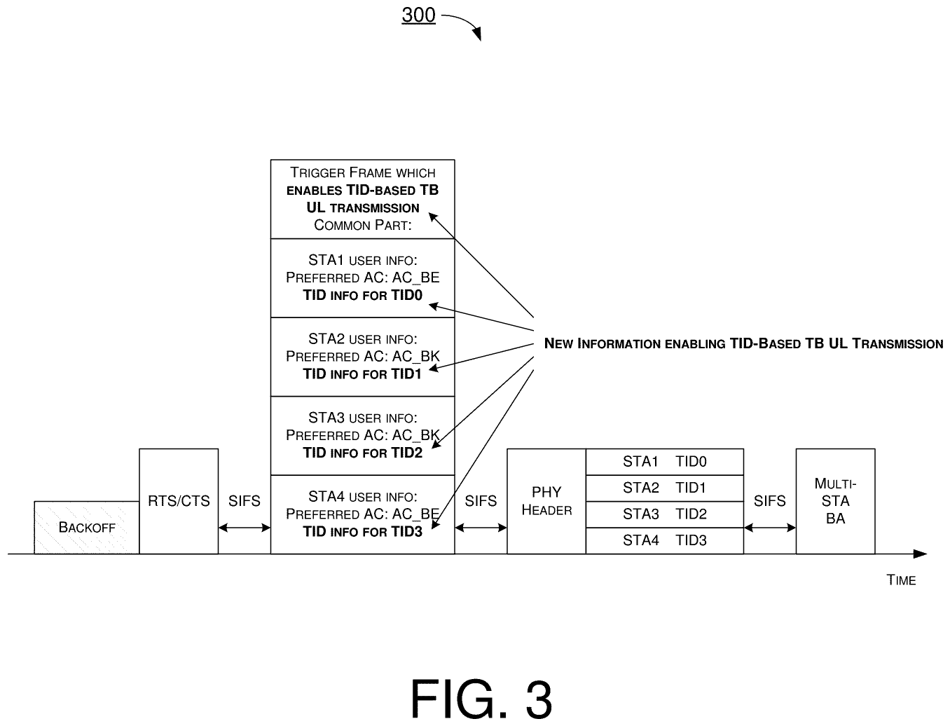

FIG. 3 illustrates an example scenario 300 under a proposed scheme in accordance with the present disclosure. Scenario 300 may pertain to a TID-based UL TB scheme in a homogenous mode in which all STAs support TID-based UL TB (and hence the homogeneous mode is not backward compatible with legacy WiFi STAs). In scenario 300, an AP (e.g., STA 110) may be in wireless communications with multiple STAs, such as STA1, STA2, STA3 and STA4, for example, and TID-based UL TB transmission in accordance with the present disclosure may be supported by each of STA1, STA2, STA3 and STA4. Moreover, in scenario 300, STA1 may have UL traffic for transmission corresponding to the AC of best effort (BE), or AC_BE; STA2 may have UL traffic for transmission corresponding to the AC of background (BK), or AC_BK; STA3 may have UL traffic for transmission corresponding to the AC of AC_BK; and STA4 may have UL traffic for transmission corresponding to the AC of AC_BE.

Referring to FIG. 3, after an exchange of request-to-send (RTS) and clear-to-send (CTS) frames, the AP may transmit a trigger frame to the multiple STAs, and the trigger frame may enable TID-based TB transmission under the proposed scheme. For instance, the user part of the trigger frame may include or otherwise indicate TID information (TID0) for STA1, TID information (TID1) for STA2, TID information (TID2) for STA3, and TID information (TID3) for STA4. The data request of TID0, TID1, TID2 and TID3 may be generated by a TID-based trigger frame generator in the AP. Correspondingly, each of the TID0, TID1, TID2 and TID3 may be handled by a respective TID-based trigger frame handler in each of STA1, STA2, STA3 and STA4. In response to receiving the trigger frame, STA1 may perform UL transmission of a traffic (data) associated with TID0 to the AP; STA2 may perform UL transmission of a traffic (data) associated with TID1 to the AP; STA3 may perform UL transmission of a traffic (data) associated with TID2 to the AP; and STA4 may perform UL transmission of a traffic (data) associated with TID3 to the AP. The AP may reply with a multi-STA block acknowledgement (BA) to indicate receipt of the UL transmissions. The time gap between adjacent transmissions may be, for example, a short interframe space (SIFS).

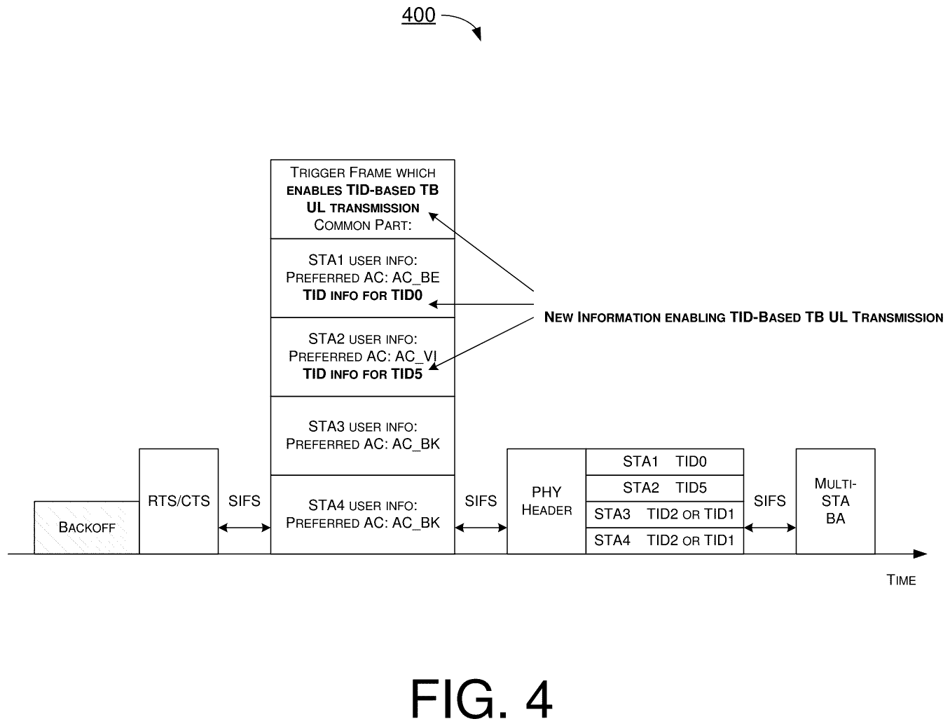

FIG. 4 illustrates an example scenario 400 under a proposed scheme in accordance with the present disclosure. Scenario 400 may pertain to a TID-based UL TB scheme in a hybrid mode, which may be backward compatible with legacy Wi-Fi STAs as in the hybrid mode not all STAs support TID-based UL TB. In scenario 400, an AP (e.g., STA 110) may be in wireless communications with multiple STAs, such as STA1, STA2, STA3 and STA4, for example. Different from scenario 300, in scenario 400, TID-based UL TB transmission in accordance with the present disclosure may be supported by each of STA1 and STA2 but not STA3 or STA4, as each of STA3 and STA4 may be a legacy STA that only supports AC-based UL TB transmission. Furthermore, in scenario 400, STA1 may have UL traffic for transmission corresponding to the AC of AC_BE; STA2 may have UL traffic for transmission corresponding to the AC of AC_VI; STA3 may have UL traffic for transmission corresponding to the AC of AC_BK; and STA4 may have UL traffic for transmission corresponding to the AC of AC_BK.

Referring to FIG. 4, after an exchange of RTS and CTS frames, the AP may transmit a trigger frame to the multiple STAs, and the trigger frame may enable TID-based TB transmission under the proposed scheme. For instance, the user part of the trigger frame may include or otherwise indicate TID information (TID0) for STA1 and TID information (TID5) for STA2. Such TID-based TB enabling information may be ignored or otherwise disregarded by the AC-based STAs (STA3 and STA4). The data request of TID0 and TID5 may be generated by a TID-based trigger frame generator in the AP. Correspondingly, each of the TID0 and TID5 may be handled by a respective TID-based trigger frame handler in each of STA1 and STA2. In response to receiving the trigger frame, STA1 may perform UL transmission of a traffic (data) associated with TID0 to the AP; STA2 may perform UL transmission of a traffic (data) associated with TID5 to the AP; STA3 may perform UL transmission of a traffic (data) associated with TID2 or TID1 (as TID1 and TID2 correspond to AC_BK) to the AP; and STA4 may perform UL transmission of a traffic (data) associated with TID2 or TID1 (as TID1 and TID2 correspond to AC_BK) to the AP. The AP may reply with a multi-STA BA to indicate receipt of the UL transmissions. The time gap between adjacent transmissions may be, for example, a SIFS.

In view of the above, the various proposed schemes in accordance with the present disclosure may utilize a TID-based UL trigger frame generator for Wi-Fi APs and a TID-based trigger frame handler for Wi-Fi STAs. Accordingly, multiple UL streams with different TIDs may be triggered by an AP and transmitted by a STA. Although current Wi-Fi standards may only define AC-based UL trigger for TB data, in next-generation Wi-Fi stands (such as Wi-Fi 7, Wi-Fi 8 and beyond), STAs may utilize SCS information to describe the precise traffic by TID. Moreover, the various proposed schemes may be backward compatible with current Wi-Fi standards even when legacy STAs do not support TID-based UL trigger frame. That is, TID-based STAs and AC-based STAs may still be triggered by a same trigger frame.

### Illustrative Implementations

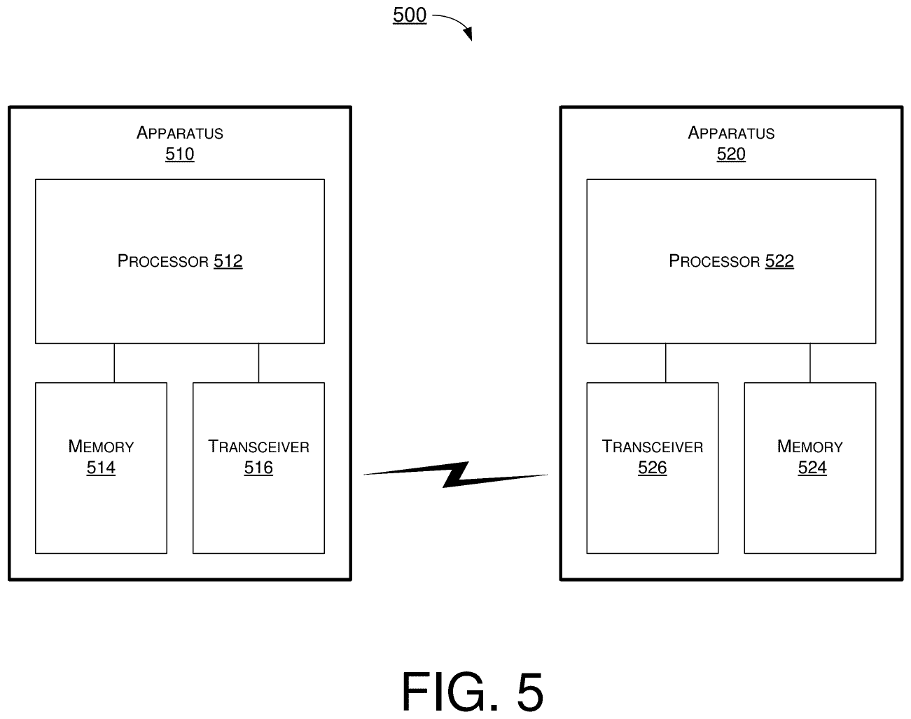

FIG. 5 illustrates an example system 500 having at least an example apparatus 510 and an example apparatus 520 in accordance with an implementation of the present disclosure. Each of apparatus 510 and apparatus 520 may perform various functions to implement schemes, techniques, processes and methods described herein pertaining to TID-based UL trigger in wireless communications, including the various schemes described above with respect to various proposed designs, concepts, schemes, systems and methods described above as well as processes described below. For instance, apparatus 510 may be implemented in STA 110 and apparatus 520 may be implemented in STA 120, or vice versa.

Each of apparatus 510 and apparatus 520 may be a part of an electronic apparatus, which may be a non-AP STA or an AP STA, such as a portable or mobile apparatus, a wearable apparatus, a wireless communication apparatus or a computing apparatus. When implemented in a STA, each of apparatus 510 and apparatus 520 may be implemented in a smartphone, a smart watch, a personal digital assistant, a digital camera, or a computing equipment such as a tablet computer, a laptop computer or a notebook computer. Each of apparatus 510 and apparatus 520 may also be a part of a machine type apparatus, which may be an IoT apparatus such as an immobile or a stationary apparatus, a home apparatus, a wire communication apparatus or a computing apparatus. For instance, each of apparatus 510 and apparatus 520 may be implemented in a smart thermostat, a smart fridge, a smart door lock, a wireless speaker or a home control center. When implemented in or as a network apparatus, apparatus 510 and/or apparatus 520 may be implemented in a network node, such as an AP in a WLAN.

In some implementations, each of apparatus 510 and apparatus 520 may be implemented in the form of one or more integrated-circuit (IC) chips such as, for example and without limitation, one or more single-core processors, one or more multi-core processors, one or more reduced-instruction set computing (RISC) processors, or one or more complex-instruction-set-computing (CISC) processors. In the various schemes described above, each of apparatus 510 and apparatus 520 may be implemented in or as a STA or an AP. Each of apparatus 510 and apparatus 520 may include at least some of those components shown in FIG. 5 such as a processor 512 and a processor 522, respectively, for example. Each of apparatus 510 and apparatus 520 may further include one or more other components not pertinent to the proposed scheme of the present disclosure (e.g., internal power supply, display device and/or user interface device), and, thus, such component(s) of apparatus 510 and apparatus 520 are neither shown in FIG. 5 nor described below in the interest of simplicity and brevity.

In one aspect, each of processor 512 and processor 522 may be implemented in the form of one or more single-core processors, one or more multi-core processors, one or more RISC processors or one or more CISC processors. That is, even though a singular term “a processor” is used herein to refer to processor 512 and processor 522, each of processor 512 and processor 522 may include multiple processors in some implementations and a single processor in other implementations in accordance with the present disclosure. In another aspect, each of processor 512 and processor 522 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 512 and processor 522 is a special-purpose machine specifically designed, arranged and configured to perform specific tasks including those pertaining to TID-based UL trigger in wireless communications in accordance with various implementations of the present disclosure.

In some implementations, apparatus 510 may also include a transceiver 516 coupled to processor 512. Transceiver 516 may include a transmitter capable of wirelessly transmitting and a receiver capable of wirelessly receiving data. In some implementations, apparatus 520 may also include a transceiver 526 coupled to processor 522. Transceiver 526 may include a transmitter capable of wirelessly transmitting and a receiver capable of wirelessly receiving data. It is noteworthy that, although transceiver 516 and transceiver 526 are illustrated as being external to and separate from processor 512 and processor 522, respectively, in some implementations, transceiver 516 may be an integral part of processor 512 as a system on chip (SoC), and transceiver 526 may be an integral part of processor 522 as a SoC.

In some implementations, apparatus 510 may further include a memory 514 coupled to processor 512 and capable of being accessed by processor 512 and storing data therein. In some implementations, apparatus 520 may further include a memory 524 coupled to processor 522 and capable of being accessed by processor 522 and storing data therein. Each of memory 514 and memory 524 may include a type of random-access memory (RAM) such as dynamic RAM (DRAM), static RAM (SRAM), thyristor RAM (T-RAM) and/or zero-capacitor RAM (Z-RAM). Alternatively, or additionally, each of memory 514 and memory 524 may include a type of read-only memory (ROM) such as mask ROM, programmable ROM (PROM), erasable programmable ROM (EPROM) and/or electrically erasable programmable ROM (EEPROM). Alternatively, or additionally, each of memory 514 and memory 524 may include a type of non-volatile random-access memory (NVRAM) such as flash memory, solid-state memory, ferroelectric RAM (FeRAM), magnetoresistive RAM (MRAM) and/or phase-change memory.

Each of apparatus 510 and apparatus 520 may be a communication entity capable of communicating with each other using various proposed schemes in accordance with the present disclosure. For illustrative purposes and without limitation, a description of capabilities of apparatus 510, as STA 110, and apparatus 520, as STA 120, is provided below in the context of example processes 600 and 700. It is noteworthy that, although a detailed description of capabilities, functionalities and/or technical features of either of apparatus 510 and apparatus 520 is provided below, the same may be applied to the other of apparatus 510 and apparatus 520 although a detailed description thereof is not provided solely in the interest of brevity. It is also noteworthy that, although the example implementations described below are provided in the context of WLAN, the same may be implemented in other types of networks.

### Illustrative Processes

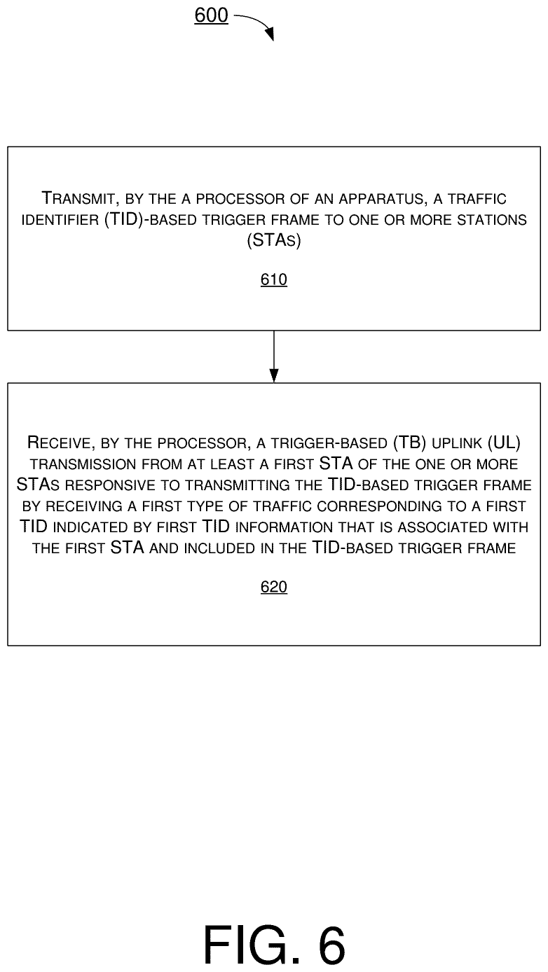

FIG. 6 illustrates an example process 600 in accordance with an implementation of the present disclosure. Process 600 may represent an aspect of implementing various proposed designs, concepts, schemes, systems and methods described above. More specifically, process 600 may represent an aspect of the proposed concepts and schemes pertaining to TID-based UL trigger in wireless communications in accordance with the present disclosure. Process 600 may include one or more operations, actions, or functions as illustrated by one or more of blocks 610 and 620. Although illustrated as discrete blocks, various blocks of process 600 may be divided into additional blocks, combined into fewer blocks, or eliminated, depending on the desired implementation. Moreover, the blocks/sub-blocks of process 600 may be executed in the order shown in FIG. 6 or, alternatively, in a different order. Furthermore, one or more of the blocks/sub-blocks of process 600 may be executed repeatedly or iteratively. Process 600 may be implemented by or in apparatus 510 and apparatus 520 as well as any variations thereof. Solely for illustrative purposes and without limiting the scope, process 600 is described below in the context of apparatus 510 implemented in or as STA 110 functioning as an AP STA of a wireless network such as a WLAN in network environment 100 in accordance with one or more of IEEE 802.11 standards. Process 600 may begin at block 610.

At 610, process 600 may involve processor 512 of apparatus 510, as an AP STA, transmitting, via transceiver 516, a TID-based trigger frame to one or more STAs. Process 600 may proceed from 610 to 620.

At 620, process 600 may involve processor 512 receiving, via transceiver 516, a TB UL transmission from at least a first STA of the one or more STAs responsive to transmitting the TID-based trigger frame. In receiving the TB UL transmission, process 600 may involve processor 512 receiving a first type of traffic corresponding to a first TID indicated by first TID information that is associated with the first STA and included in the TID-based trigger frame.

In some implementations, in transmitting the TID-based trigger frame, process 600 may involve processor 512 generating the TID-based trigger frame using a TID-based UL trigger frame generator.

In some implementations, the TID-based trigger frame may further include second TID information associated with a second STA of the one or more STAs. Moreover, the second TID information may indicate a second TID. In such cases, in receiving the TB UL transmission, process 600 may further involve processor 512 receiving a second type of traffic corresponding to the second TID and from the second STA.

In some implementations, the one or more STAs may further include a third STA that does not support the TID-based trigger frame (e.g., the third STA may be a legacy STA such as, for example, an AC-based STA). In such cases, the TID-based trigger frame may further include pertinent information (e.g., AC information) for the third STA. Moreover, in receiving the TB UL transmission, process 600 may further involve processor 512 receiving a third type of traffic corresponding to the AC information and from the third STA. The third type of traffic may correspond to a third TID that is associated with the AC information.

In some implementations, in receiving the TB UL transmission, process 600 may involve processor 512 receiving a HE or EHT TB transmission.

FIG. 7 illustrates an example process 700 in accordance with an implementation of the present disclosure. Process 700 may represent an aspect of implementing various proposed designs, concepts, schemes, systems and methods described above. More specifically, process 700 may represent an aspect of the proposed concepts and schemes pertaining to TID-based UL trigger in wireless communications in accordance with the present disclosure. Process 700 may include one or more operations, actions, or functions as illustrated by one or more of blocks 710 and 720. Although illustrated as discrete blocks, various blocks of process 700 may be divided into additional blocks, combined into fewer blocks, or eliminated, depending on the desired implementation. Moreover, the blocks/sub-blocks of process 700 may be executed in the order shown in FIG. 7 or, alternatively, in a different order. Furthermore, one or more of the blocks/sub-blocks of process 700 may be executed repeatedly or iteratively. Process 700 may be implemented by or in apparatus 510 and apparatus 520 as well as any variations thereof. Solely for illustrative purposes and without limiting the scope, process 700 is described below in the context of apparatus 520 implemented in or as STA 120 functioning as a non-AP STA of a wireless network such as a WLAN in network environment 100 in accordance with one or more of IEEE 802.11 standards. Process 700 may begin at block 710.

At 710, process 700 may involve processor 522 of apparatus 520, as a first STA, receiving, via transceiver 526, a TID-based trigger frame. Process 700 may proceed from 710 to 720.

At 720, process 700 may involve processor 522 performing, via transceiver 526, a TB UL transmission responsive to receiving the TID-based trigger frame. In performing the TB UL transmission, process 700 may involve processor 522 transmitting a first type of traffic corresponding to a first TID indicated by first TID information that is associated with the first STA and included in the TID-based trigger frame.

In some implementations, in receiving the TID-based trigger frame, process 700 may involve processor 522 handling the TID-based trigger frame using a TID-based UL trigger frame handler.

In some implementations, the TID-based trigger frame may further include second TID information associated with a second STA. Moreover, the second TID information may indicate a second TID.

In some implementations, the TID-based trigger frame may further include AC information for a third STA that is an AC-based STA (e.g., legacy STA).

In some implementations, in performing the TB UL transmission, process 700 may involve processor 522 performing a HE or EHT TB transmission.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
transmitting, by the a processor of an apparatus, a traffic identifier (TID)-based trigger frame to one or more stations (STAs); and
receiving, by the processor, a trigger-based (TB) uplink (UL) transmission from at least a first STA of the one or more STAs responsive to transmitting the TID-based trigger frame,
wherein the receiving of the TB UL transmission comprises receiving a first type of traffic corresponding to a first TID indicated by first TID information that is associated with the first STA and included in the TID-based trigger frame.

2. The method of claim 1, wherein the transmitting of the TID-based trigger frame comprises generating the TID-based trigger frame using a TID-based UL trigger frame generator.

3. The method of claim 1, wherein the TID-based trigger frame further comprises second TID information associated with a second STA of the one or more STAs, and wherein the second TID information indicates a second TID.

4. The method of claim 3, wherein the receiving of the TB UL transmission further comprises receiving a second type of traffic corresponding to the second TID and from the second STA.

5. The method of claim 1, wherein the one or more STAs further comprise a third STA that does not support the TID-based trigger frame, and wherein the TID-based trigger frame further comprises pertinent information for the third STA.

6. The method of claim 5, wherein the receiving of the TB UL transmission further comprises receiving a third type of traffic corresponding to the AC information and from the third STA.

7. The method of claim 6, wherein the third type of traffic corresponds to a third TID that is associated with the AC information.

8. The method of claim 1, wherein the receiving of the TB UL transmission comprises receiving a high-efficiency (HE) or extremely-high-throughput (EHT) TB transmission.

9. A method, comprising:
receiving, by a processor of an apparatus implemented in a first station (STA), a traffic identifier (TID)-based trigger frame; and
performing, by the processor, a trigger-based (TB) uplink (UL) transmission responsive to receiving the TID-based trigger frame,
wherein the performing of the TB UL transmission comprises transmitting a first type of traffic corresponding to a first TID indicated by first TID information that is associated with the first STA and included in the TID-based trigger frame.

10. The method of claim 9, wherein the receiving of the TID-based trigger frame comprises handling the TID-based trigger frame using a TID-based UL trigger frame handler.

11. The method of claim 9, wherein the TID-based trigger frame further comprises second TID information associated with a second STA, and wherein the second TID information indicates a second TID.

12. The method of claim 9, wherein the TID-based trigger frame further comprises access category (AC) information for a third STA that is an AC-based STA.

13. An apparatus, comprising:
a transceiver configured to communicate wirelessly; and
a processor coupled to the transceiver and configured to perform operations comprising:
transmitting, via the transceiver, a traffic identifier (TID)-based trigger frame to one or more stations (STAs); and
receiving, via the transceiver, a trigger-based (TB) uplink (UL) transmission from at least a first STA of the one or more STAs responsive to transmitting the TID-based trigger frame,
wherein the receiving of the TB UL transmission comprises receiving a first type of traffic corresponding to a first TID indicated by first TID information that is associated with the first STA and included in the TID-based trigger frame.

14. The apparatus of claim 13, wherein the transmitting of the TID-based trigger frame comprises generating the TID-based trigger frame using a TID-based UL trigger frame generator.

15. The apparatus of claim 13, wherein the TID-based trigger frame further comprises second TID information associated with a second STA of the one or more STAs, and wherein the second TID information indicates a second TID.

16. The apparatus of claim 15, wherein the receiving of the TB UL transmission further comprises receiving a second type of traffic corresponding to the second TID and from the second STA.

17. The apparatus of claim 13, wherein the one or more STAs further comprise a third STA that does not support the TID-based trigger frame, and wherein the TID-based trigger frame further comprises pertinent information for the third STA.

18. The apparatus of claim 17, wherein the receiving of the TB UL transmission further comprises receiving a third type of traffic corresponding to the AC information and from the third STA.

19. The apparatus of claim 18, wherein the third type of traffic corresponds to a third TID that is associated with the AC information.

20. The apparatus of claim 13, wherein the receiving of the TB UL transmission comprises receiving a high-efficiency (HE) or extremely-high-throughput (EHT) TB transmission.
